(19) United States
(12) Patent Application Publication
(10) Pub. No.: US 2008/0244911 A1
(43) Pub. Date: Oct. 9, 2008

(54) Dual-use knife for cutting a circle and a straight line

(76) Inventor: Pi-Chao Chang, Taichung County (TW)

Correspondence Address: Pi-Chao Chang, P.O. Box 44-2049, Taipei, 10668, TW

(21) Appl. No.: 11/783,307

(22) Filed: Apr. 9, 2007

(51) Int. Cl. B26B 1/08

(52) U.S. Cl. 30/162

(57) ABSTRACT

A dual-use knife for cutting a circle and a straight line has exchangeable circular blade upper covers to provide the function of cutting the circle or the straight line. The knife has quick release fasteners to be moved in guiding grooves of a handle so that thick and thin circular blade upper covers may be released from or fastened to a push-control member and an accommodating slot. Also, moving the push-control member in the groove can control the front circular blade to extend out for cutting or to be retracted so that the knife has two functions.

### BACKGROUND OF THE INVENTION

(1) Field of the Invention

The invention relates to a dual-use knife for cutting a circle and a straight line in a convenient manner, wherein the knife has a quick release fastener to be moved in a guiding groove so that thick and thin circular blade upper covers for cutting the straight line and the circle can be fastened or released quickly.

(2) Description of the Prior Art

At present, the available circular blade is often used to cut a straight line in conjunction with a linear ruler, or may be used in conjunction with a cutting board formed with tracks so that some special shapes may be cut. This type of circular blade can indeed replace the conventional knife having the drawbacks that the force cannot be easily applied and the blade tends to break, so that the user may use the knife in a more conveniently and safer way.

Furthermore, the circular blade upper cover cannot be too large if the circular blade is used to cut the straight line. In other words, a large space for the blade has to be reserved so that the user may hold the knife at various angles with the hand without interfering the cutting space.

Also, the circular blade upper cover has to be configured to satisfy the width of the track if the circular blade is used in conjunction with the cutting board formed with the tracks. Thus, it is possible to ensure the cut shape to be regular without deformation and deviation.

Although the circular blade can improve the drawback of the conventional knife, the two circular blades have different uses. So, the user has to purchase two kinds of circular blades to achieve the advantage of cutting different shapes. In addition, the circular blade is more expensive than the conventional knife. So, the economic consideration cannot be satisfied, and the prior art still has to be improved.

In addition, purchasing two sets of circular blades wastes a lot of time and a lot of costs in maintaining the blades or exchanging the blades. Also, it is inconvenient to the user who wants to carry the blades. Thus, the prior art cannot provide utility and convenient properties for the user, and thus has to be improved.

### SUMMARY OF THE INVENTION

In view of the drawbacks of the prior art circular blades, an object of the invention is to provide a dual-use knife for cutting a circle and a straight line according to the experiences in manufacturing the associated products. The dual-use knife has thick and thin circular blade upper covers, which may be quickly fastened to or released from a push-control member or an accommodating slot. Moving a quick release fastener in a guiding groove can fasten or release the circular blade upper covers so that the circular blade upper covers can be quickly exchanged and used.

Another object of the invention is to reinforce the structure of a dual-use knife for cutting a circle and a straight line through a handle and slots on the front side and the back side of the handle so that the structure of the handle can be reinforced and the lifetime of the knife can be lengthened. In addition, through holes formed on two sides of the push-control member still can reinforce the structure of the handle so that the blade head can withstand the larger pressure without deformation or break. Thus, the knife of the invention has the utility and the durability and may be manufactured with the reduced cost.

To achieve the above-identified object, the structure of the invention fastens or releases thick and thin circular blade upper covers in a guiding groove using a quick release fastener. Also, a push-control member is moved in a slot to control a circular blade to be pushed out or retracted into a handle. Also, different circular blade upper covers may be exchanged according to the requirement in use so that the working efficiency is increased.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing a structure of a dual-use knife for cutting a circle and a straight line according to the invention.

FIG. 2 is a schematic illustration showing a back side structure of the dual-use knife according to the invention.

FIG. 3 shows an operation for exchanging circular blade upper covers in the dual-use knife of the invention.

FIG. 4 is a schematic illustration showing the circular blade upper covers are exchanged in the dual-use knife of the invention.

FIG. 5 is a schematic illustration showing a retractable push-control member in the dual-use knife of the invention.

FIG. 6 shows the dual-use knife according to the embodiment of the invention.

### DETAILED DESCRIPTION OF THE PREFERRED EMBODIMENTS

The structure, technological means and effect of the invention will be described with reference to the accompanying drawings according to the preferred embodiment of the invention.

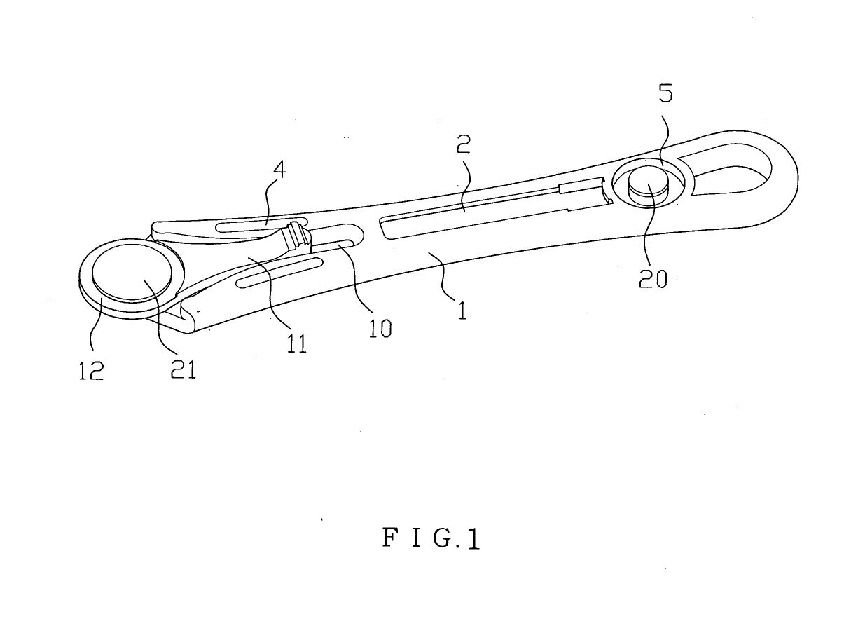

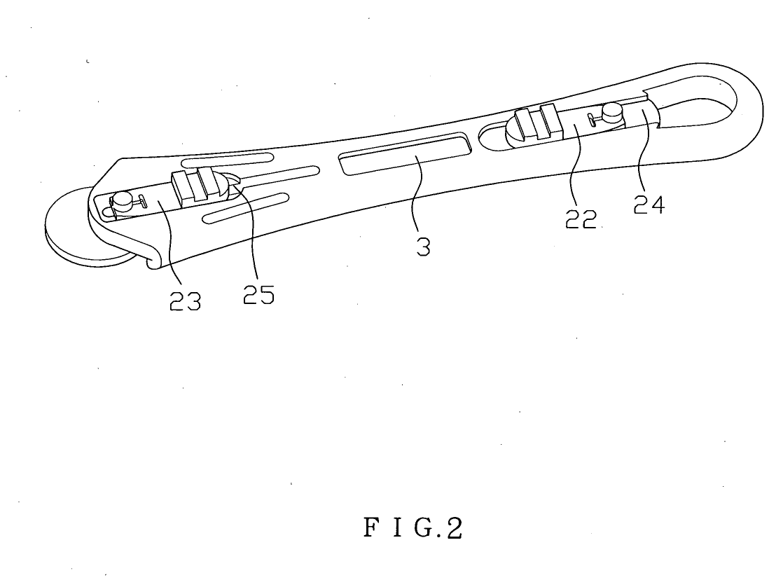

FIG. 1 is a schematic illustration showing a structure of a dual-use knife for cutting a circle and a straight line according to the invention. FIG. 2 is a schematic illustration showing a back side structure of the dual-use knife according to the invention. Referring to FIGS. 1 and 2, the dual-use knife of the invention mainly includes a handle 1, a push-control member 11 and two quick release fasteners 22 and 23. Front and back sides of the handle 1 are formed with reinforcing slots 2 and 3 for reinforcing the overall structure of the handle 1. Also, two sides of the push-control member 11 are formed with reinforcing through holes 4 for dispersing up and down pressures individually applied to the push-control member 11 when the user is operating the push-control member 11. The reinforcing through holes 4 have the effect of reinforcing the structure of the handle 1 and thus lengthen the lifetime of the knife.

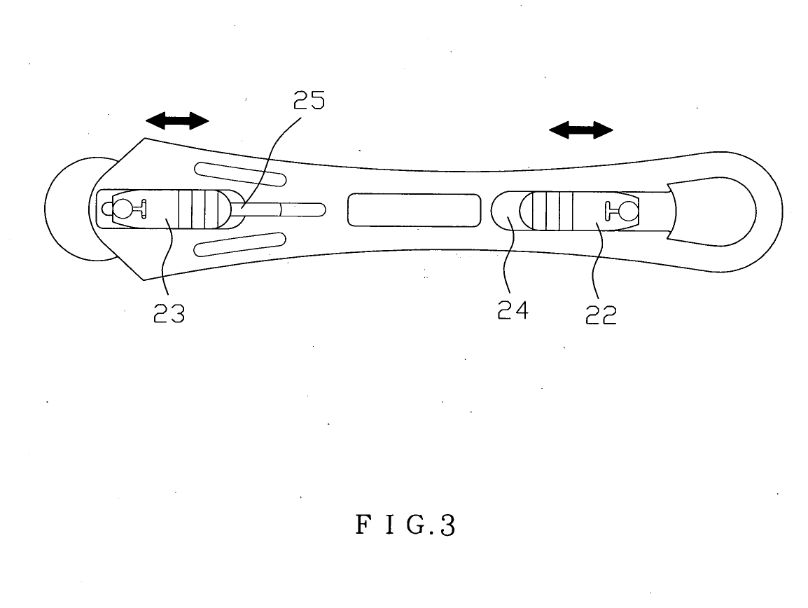

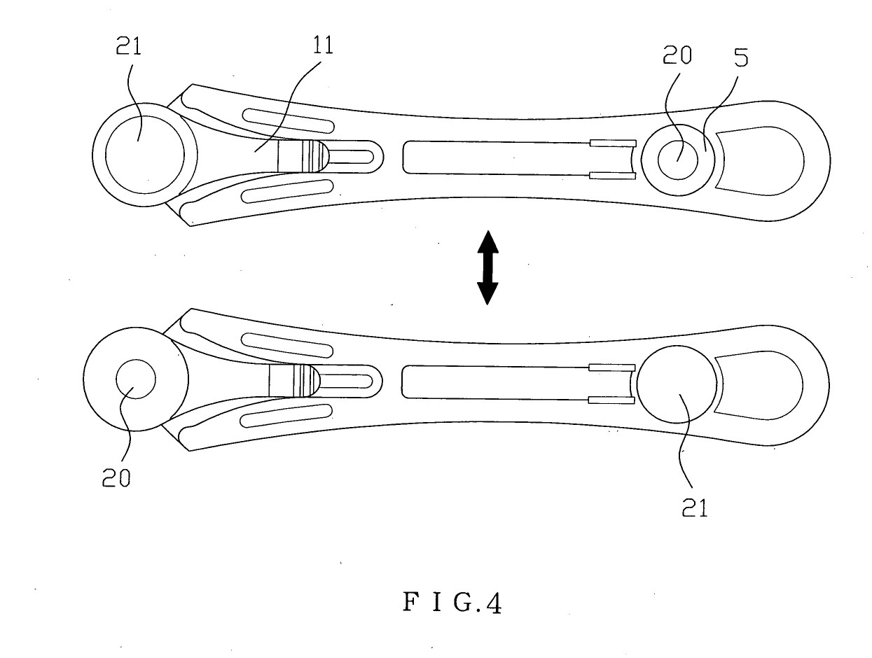

FIG. 3 shows an operation for exchanging circular blade upper covers in the dual-use knife of the invention. FIG. 4 is a schematic illustration showing the circular blade upper covers are exchanged in the dual-use knife of the invention. As shown in FIGS. 3 and 4, a thin circular blade upper cover 20 and a thick circular blade upper cover 21 are moved in guiding grooves 24 and 25 through the quick release fasteners 22 and 23, respectively, so that the thin and thick circular blade upper covers 20 and 21 can be fastened to or released from the push-control member 11 and an accommodating slot 5. When the front end of the push-control member 11 is combined with the thin circular blade upper cover 20, the knife is in a state of cutting a straight line. Also, if the front end of the push-control member 11 is combined with the thick circular blade upper cover 21, the knife is in a state of cutting a circular or a circular-like shape. Thus, the thin and thick circular blade upper covers 20 and 21 for respectively cutting a straight line and a circular shape can be quickly exchanged, and the structure of the knife has the economic property and the utility.

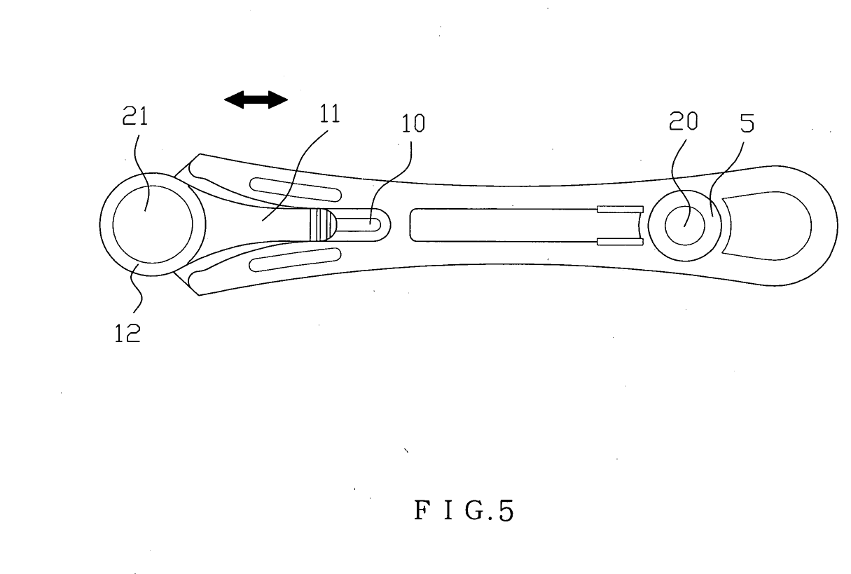

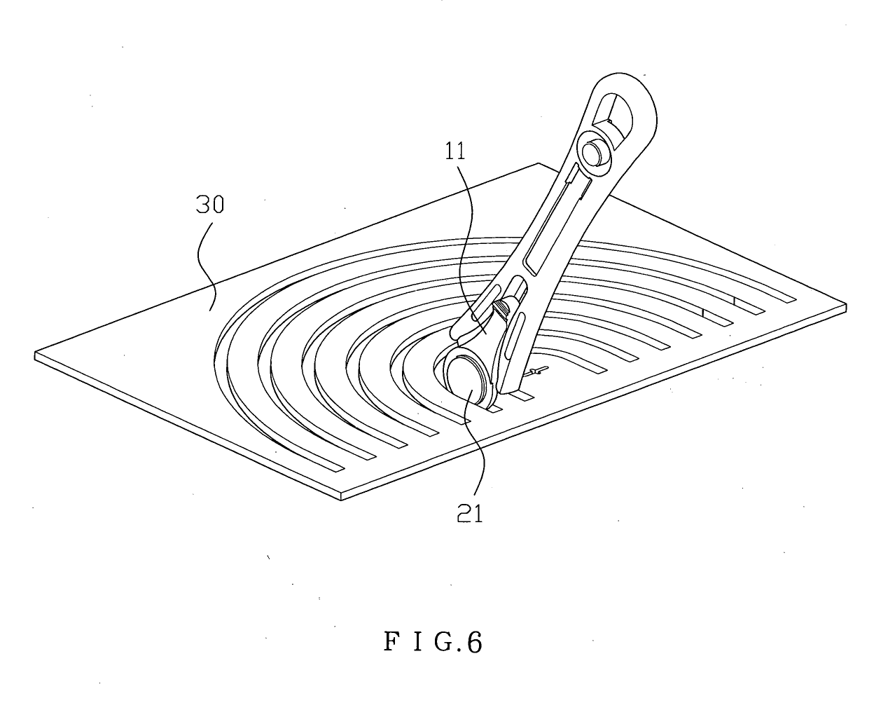

FIG. 5 is a schematic illustration showing a retractable push-control member in the dual-use knife of the invention. As shown in FIG. 5, the push-control member 11 may be moved in a slot 10 so that a blade 12 can extend out of or be retracted into the slot of the handle 1. Also, as shown in FIG. 6, when the thick circular blade upper cover 21 is attached to the blade 12, the overall width thereof satisfies the width of the track on a cutting board 30. Thus, it is possible to ensure the regular cutting track without deformation and deviation.

In summary, the dual-use knife of the invention has the reinforced handle structure and enables the thick and thin circular blade upper covers to be attached to either the push-control member or the accommodating slot. Also, the two circular blade upper covers can be quickly fastened or released through the movement of the quick release fastener in a very convenient manner, and the cost of maintaining and purchasing the blades may be decreased. Consequently, the dual-use knife has the extremely high value and the extremely high utility in the industry.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A dual-use knife, mainly comprising:
a handle having a slot, which is formed on a front end of a front side of the handle and is for accommodating a circular blade, a predetermined accommodating slot, which is formed on a rear end of the handle, and guiding grooves, which are formed on front and rear ends of a back side of the handle;
a push-control member disposed in the slot of the handle, wherein a front end of the push-control member may be attached to the circular blade, and the blade may extend out of the slot and be retracted into the slot when the push-control member is moved back and forth;
two circular blade upper covers, which have different thicknesses, and may be fixed to an external side of the blade at the front end of the push-control member or may be fixed in the accommodating slot without falling down; and
two quick release fasteners respectively disposed in the grooves, wherein the quick release fasteners are pushed back and forth so that the circular blade upper covers on the push-control member and in the accommodating slot may be fastened or released,
wherein the circular blade upper covers comprise a thin circular blade upper cover for cutting a straight line and a thick circular blade upper cover for cutting a circular shape or a circular-like shape, and may be quickly exchanged between the push-control member and the accommodating slot.

2. The dual-use knife according to claim 1, wherein the push-control member and one of the quick release fasteners corresponding to the push-control member are moved simultaneously.

3. The dual-use knife according to claim 1, wherein when the front end of the push-control member is combined with the thin circular blade upper cover, the knife is in a state of cutting the straight line.

4. The dual-use knife according to claim 1, wherein when the front end of the push-control member is combined with the thick circular blade upper cover, the knife is in a state of cutting the circular shape or the circular-like shape.
